(19) United States
(12) Patent Application Publication
(10) Pub. No.: US 2014/0220352 A1
(43) Pub. Date: Aug. 7, 2014

(54) ULTRA VIOLET ENHANCED RESPONSE PHOTOCHROMIC COMPOSITION AND DEVICE

(71) Applicant: KILOLAMBDA TECHNOLOGIES LTD., Tel-Aviv (IL)

(72) Inventors: Noam Gross, Kiryat Ono (IL); Ariela Donval, Rosh-Haayin (IL); Moshe Oron, Rehovot (IL); Doron Nevo, Ra'anana (IL)

(73) Assignee: KiloLambda Technologies Ltd., Tel-Aviv (IL)

(21) Appl. No.: 13/759,756

(22) Filed: Feb. 5, 2013

(51) Int. Cl. G02B 5/23; B32B 5/00

(52) U.S. Cl. CPC G02B 5/23; B32B 5/00
USPC 428/411.1; 252/586

(57) ABSTRACT

The present invention relates to an optical power-limiting composition for limiting optical power transmission for an entire solar UV spectrum. The composition includes photochromic dye molecules and UV fluorescent nanoparticles in a matrix material. The composition is configured to absorb wavelengths in the entire solar UV spectrum, including wavelengths of 300-340 nm, thereby enhancing photochromic responsiveness of the composition to solar light. The composition includes a first side that receives impinging light and a second side opposed to the first side.

### FIELD OF THE INVENTION

The present invention relates to optical power-limiting devices, and more particularly, to an optical power-limiting passive (self-adaptive) device and to a method for limiting optical power transmission in devices such as lenses and windows, using absorption changes in a novel photochromic composition that exploit the full solar ultraviolet (UV) light spectrum. While a typical photochromic material is activated only by longer UV wavelengths, e.g., 340 to 420 nm, this composition allows the photochromic material to use the shorter UV wavelengths in the solar spectrum as well, e.g. wavelengths shorter than 340 nm, thus enhancing the photochromic response to solar light.

The present invention further relates to, but is not limited to, the production of windows, lenses, contact lenses, microlenses, mirrors and other optical articles. The present invention further relates to protecting dedicated optical elements against sun blinding, flash blinding, flash dazzling, flashing lights originating from explosions in battle fields, welding light, fire related blinding, and lenses for cameras that look directly at the sun or missile launching sites, and other bright emitting sources that contain UV light in their spectrum.

### BACKGROUND OF THE INVENTION

Photochromic materials are known to exhibit a change in light transmission or color in response to actinic radiation in the spectrum of sunlight. Removal of the incident radiation causes these materials to gradually revert back to their original transmissive state.

Photochromic materials have applications such as sunglasses, graphics, ophthalmic lenses, solar control window films, security and authenticity labels, and many others. The use of photochromic materials, however, has been limited for a number of reasons, including due to (a) degradation of the photochromic property of the materials (fatigue) as a result of continued exposure to UV light, particularly to the shorter and more energetic wavelengths (shorter than 340 nm wavelength) and (b) low photochromic reaction where UV radiation is scarce. The current invention addresses these and other issues.

Today, most spectacle lenses are made of a variety of plastics or plastic-glass composites. Most commonly used plastics include PMMA (e.g., PLEXIGLAS® by Arkema France Corp., PERSPEX® by Lucite International, ALTUGLAS® by Arkema France Corp., OPTIX® by Plaskolite, Inc.) and Polycarbonate (e.g., LEXAN® by SABIC Innovative Plastics, MERLON® by Mobay Chemical Company, MAKROLON® by Bayer Aktiengesellschaft Corp., and PANLITE® from Teijin Chemicals Ltd.).

### SUMMARY OF INVENTION

Some success in rendering plastic ophthalmic lenses photochromic involved embedding a solid layer of photochromic mineral glass within the bulk of an organic lens material. Examples include, inter alia, U.S. Pat. No. 5,232,637 (Dasher, et al.), the disclosure of which is incorporated by reference herein in its entirety, that teaches a method of producing a glass-plastic laminated ophthalmic lens structure, and U.S. Pat. No. 4,300,821 (Mignen et al.), the disclosure of which is incorporated by reference herein in its entirety, that teaches an ophthalmic lens made of organic material having at least one layer of photochromic mineral glass within its mass to impart photochromic properties to the lens.

All known photochromic materials exhibit a change in light transmission or color in response to actinic radiation, mainly due to the longer UV wavelengths (e.g., 340 to 420 nm). One embodiment of the present invention makes use of the harmful shorter wavelengths of the UV light in the spectrum of sunlight by converting those harmful shorter wavelengths of the UV light to the usable UV and short visible wavelengths (340 to 420 nm) via use of fluorescent nano-sized particles.

Fluorescence refers to an optical process in which absorption of a photon is followed by an emission of a different photon with a longer wavelength than the absorbed one. The fluorescence concept is well known and widely used in many applications. However, the use of fluorescence in transparent materials for practical use has been extremely limited. The limitations are largely attributed to the difficulties in preparing small fluorescing nano-crystals (e.g., sub-100 nm, much smaller than the visible light wavelength). The present invention successfully incorporates efficient fluorescence materials in photochromic devices.

One embodiment of this invention makes use of nanoscale particles, e. g., nano-crystals (NC) or quantum dots (QD) that can absorb short wavelength UV radiation and emit it back at a slightly higher wavelength. This fluorescence process can also be referred to as energy or frequency downshifting. The NC/QD should absorb UV radiation at wavelengths that are shorter than those being used by the photochromic material, i.e. a part of the spectrum that is less beneficial to the photochromic molecules (PCM). In fact, the shorter UV wavelengths can be harmful to the PCMs and without the NC/QD they would probably have to be blocked by some kind of a UV absorber. The NC/QD emit the energy back as photons, at the PCM's activation wavelength (e.g., 340 to 420 nm). This process will effectively increase the flux of efficient UV radiation that the PCMs are subjected to, thus enabling a darker tint at activation without affecting the PCM response time. In many applications there is insufficient UV and short wave visible light radiation to actuate the photochromic material. The addition of fluorescent materials enables the in-situ generation of more UV and/or short wave visible light that in turn can actuate photochromic materials and devices.

Examples for NC/QD suited for this application are, e.g., ZnO (Zinc oxide) nanoparticles (see, e.g., Decay Dynamics of ultraviolet photoluminescence in ZnO nanocryctals, S. Yamamoto et al., Journal of Luminescence 126 (2007) 257-262, the disclosure of which is incorporated herein by reference in its entirety); CdS; CdSe; gallium oxide; indium oxide; and other suitable materials.

One embodiment uses a matrix, a photochromic dye and UV fluorescent nanoparticle additives to provide a photochromic composition that reacts (tints) faster and tints stronger than without application of UV fluorescent nanoparticle additives. In this composition, the UV fluorescent nanoparticles absorb low wavelength photons, e.g., lower than 340 nm, which are re-emitted into the system as longer wavelength UV or short visible light, e.g., 340 to 420 nm. The re-emitted UV light in turn activates the photochromic material in the composition.

A further embodiment provides a composition of a matrix, a photochromic dye, UV fluorescent nanoparticle additives and environmental stabilizers.

The matrix in the photochromic compositions can be organic-based, e.g., a polymer film, a polymerizable composition, or a transparent adhesive, or inorganic-based, e.g., mineral glass, sol-gel, and any other window based material, and an inorganic-organic composite.

Specific embodiments utilize various UV fluorescent nanoparticle additives in the photochromic compositions, such as ZnO, ZnS, ZnSe, CdS, CdSe, gallium oxide, indium oxide, tin oxide or their alloys, mixtures and mixed composition particles, and any combination thereof.

Various photochromic materials that can be used in the photochromic compositions include, but are not limited to, organic and inorganic photochromics and mixtures thereof. Organic photochromic dyes can be pyrans, oxazines, fulgides, fulgimides, diarylethenes and mixtures thereof. These may be a single photochromic compound, a mixture of photochromic compounds, a material comprising a photochromic compound, such as a monomeric or polymeric ungelled solution, and a material such as a monomer or polymer to which a photochromic compound is chemically bonded. Inorganic photochromics may include crystallites of silver halides, cadmium halide and/or copper halide, or any combination thereof.

Various fluorescence enhancing materials can be used in the photochromic compositions to enhance fluorescence emission from the UV fluorescent nanoparticle additives nanoparticles, including, for example, ZnO, ZnS, ZnSe, CdS, CdSe, gallium oxide, indium oxide, tin oxide or their alloys, mixtures and mixed composition particles, and any combination thereof.

Various stabilizers that can be used in the photochromic compositions include hindered amine light stabilizer (HALS), UV absorbers, thermal stabilizers, singlet oxygen quenchers, various antioxidants, and any combination thereof

One aspect of the present invention relates to an optical power-limiting composition for limiting optical power transmission for an entire solar UV spectrum. The composition includes photochromic dye molecules and UV fluorescent nanoparticles in a matrix material. The composition is configured to absorb wavelengths in the entire solar UV spectrum, including wavelengths of 300-340 nm, thereby enhancing photochromic responsiveness of the composition to solar light. The composition includes a first side that receives impinging light and a second side opposed to the first side.

Another aspect of the present invention relates to a composition for limiting optical power transmission for the entire solar UV spectrum. The composition includes a transparent bulk material including nano-sphere capsules embedded therein. The nano-sphere capsules include photochromic dye molecules and UV fluorescent nanoparticles in a matrix. The transparent bulk material includes a first side and a second side opposing the first side.

Various nanoparticles and/or microparticles of the photochromic compositions can be further coated or encapsulated with a coating. According to one aspect of the present invention, the UV fluorescent nanoparticleas are encapsulated together with the various nanoparticles and/or microparticles. The coating can serve a number of functions, such as protection of the core composition from oxidation or any form of degradation, blocking out harmful radiation, and changing the chemical nature of the particles (hydrophobic/hydrophilic) and hence the dispersability of the nanoparticles and/or microparticles.

### BRIEF DESCRIPTION OF THE DRAWINGS

The invention will now be described in connection with certain preferred embodiments with reference to the following illustrative figures so that it may be more fully understood. With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention.

FIG. 1 depicts a cross-sectional view of photochromic molecules and UV fluorescent nanoparticle additives in bulk material.

FIG. 2 depicts a cross-sectional view of photochromic molecules and UV fluorescent nanoparticle additives in bulk material with a UV reflecting layer at the back.

FIG. 3 depicts a cross-sectional view of device composed of two layers; a photochromic molecules in bulk layer and a UV fluorescent nanoparticles in bulk layer in front of it.

FIG. 4 depicts a cross-sectional view of device composed of three layers; a photochromic molecules in bulk layer, a UV fluorescent nanoparticles in bulk layer in front of it and a UV reflecting layer at the back.

FIG. 5 depicts a cross-sectional view of a nano-sphere (capsule) containing photochromic molecules and UV fluorescent nanoparticles.

FIG. 6 depicts a cross-sectional view of the photochromic device containing nano-spheres.

FIG. 7 shows a fluorescence spectral graph of (a) ZnO and (b) CdS.

### DETAILED DESCRIPTION OF THE DRAWINGS

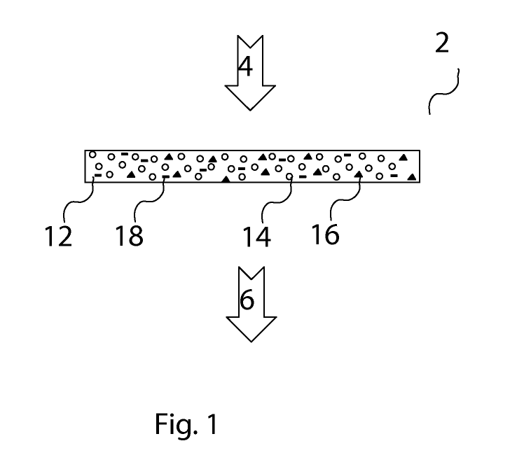

FIG. 1 is a cross-sectional view of photochromic molecules and UV fluorescent nanoparticle additives in bulk material 2, comprising a matrix 12, a photochromic material 14, UV fluorescent nanoparticle additives 16 and environmental stabilizers 18. The optical element absorbs part of a light beam 4 which impinges on it, the short wavelength UV part (e.g., shorter than 340 nm) of the impinging light beam 4 is absorbed in the fluorescent nanoparticle additives 16, converting the short wavelength UV part of the impinging light beam 4 to usable UV and short visible wavelengths (e.g. 340 to 420 nm) thereby making it available to be absorbed in the photochromic material 14. When this light is absorbed by the photochromic material 14, it reversibly changes the color and transparency of the bulk 2 (due to the absorption of light by the photochromic material 14), and effectively transmits only part of the visible light to direction 6. When the power of the entering light 4 is reduced, the transparency is resumed, and the exiting light beam 6 is about as intense as the entering light 4. The material 2 changes the bulk color and transparency when exposed to a wider range (e.g., 300-420 nm wavelength) of light than regular photochromics that react mainly at UV and short visible wavelengths (e.g., 340 to 420) nm of light.

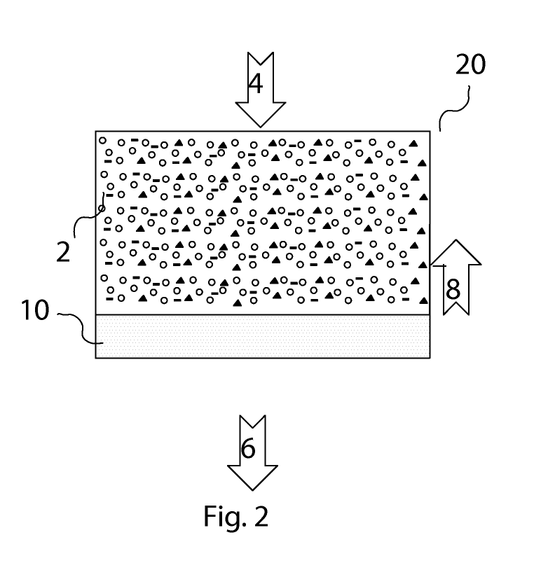

FIG. 2 shows a device 20 in cross-sectional view of photochromic molecules and UV fluorescent nanoparticle additives in bulk material 2 (as described in FIG. 1) with a UV reflecting layer (mirror) 10 at the back. When exposed to impinging light 4, a part of the light at UV and short visible wavelengths (e.g., 300 to 420 nm) is absorbed by the bulk material 2 as discussed above in relation to FIG. 1. The unabsorbed part that reaches the UV reflecting layer (mirror) 10 is back reflected in direction 8 and absorbed by the bulk material 2, thus enhancing the efficiency of the impinging light and making the exiting light 6 include a lesser amount/percentage of UV and short visible wavelengths.

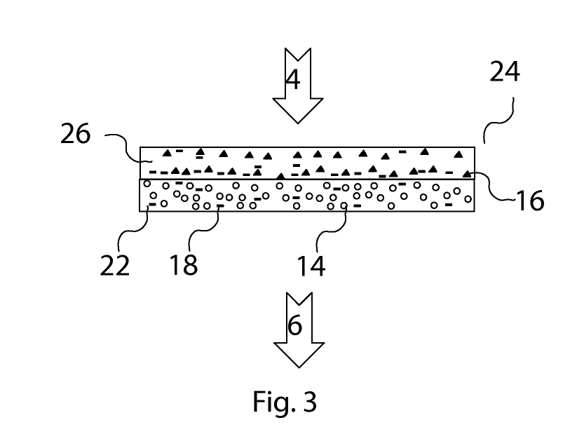

FIG. 3 depicts a cross-sectional view of a device 24 composed of two layers; photochromic molecules 14 and environmental stabilizers 18 in a bulk layer 22 and UV fluorescent nanoparticles 16 and environmental stabilizers 18 in a bulk layer 26 in front of it. The impinging light 4 is first absorbed by the bulk layer 26 that absorbs mainly in the short UV wavelengths (e.g., shorter than 340 nm) and fluoresces in the longer UV and short visible wavelength range (e.g., 340 to 420 nm). The emitted light is absorbed in the layer 22, by the photochromic molecules 14. This layer arrangement enhances the efficiency of the photochromic material since it allows the composition to use the shorter UV wavelengths which are less beneficial to the photochromic molecules.

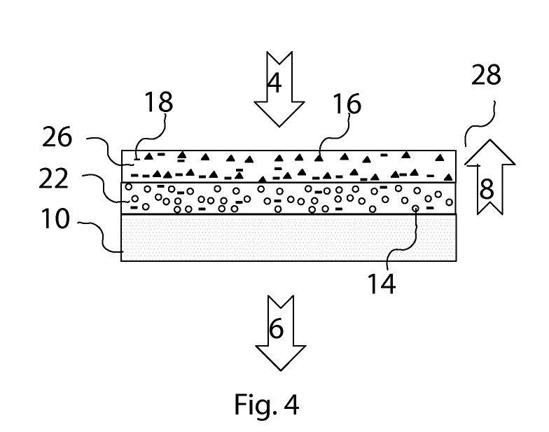

FIG. 4 depicts a cross-sectional view of device 28 composed of three layers; photochromic molecules 14 and environmental stabilizers 18 in bulk layer 22, UV fluorescent nanoparticles 16 and environmental stabilizers 18 in bulk layer 26 in front of it and a UV reflecting layer 10 at the back. When exposed to impinging light 4, part of the light, UV and short visible wavelengths (e.g., 300 to 420 nm) is absorbed in layers 22 and 26. The unabsorbed part that reaches the UV mirror 10 is back-reflected in direction 8 and absorbed by the layers 22 and 26, thus enhancing the efficiency of the impinging light and makes the exiting light 6 poorer in these wavelengths.

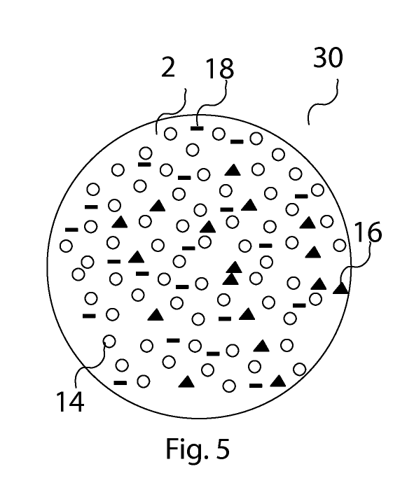

FIG. 5 depicts a cross-sectional view o f a nano-sphere (capsule) 30 containing photochromic molecules 14, UV fluorescent nanoparticles 16 and environmental stabilizers 18 in a matrix as described in FIG. 1, but having a matrix in a spherical shape of diameter of, e.g., 50-200 nm. This configuration is very efficient for embedding in bulk that is not favorable to have dispersed nanoparticles in it.

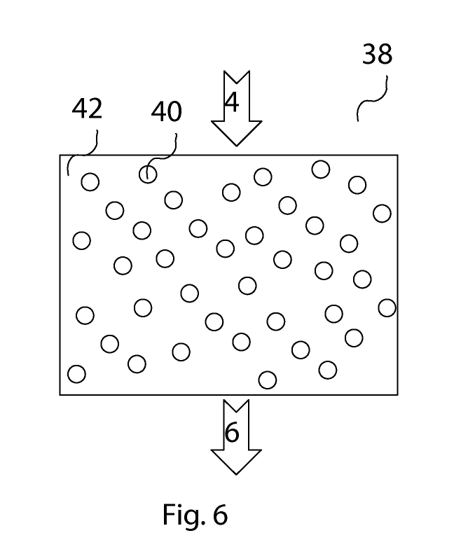

FIG. 6 depicts a cross-sectional view of the photochromic device 38 containing nano-spheres 40 in bulk 42, where matrix of bulk 42 is not favorable to have dispersed nanoparticles in it. In other words, the bulk 42 may be composed of a material that makes it difficult to disperse nanoparticles in it.

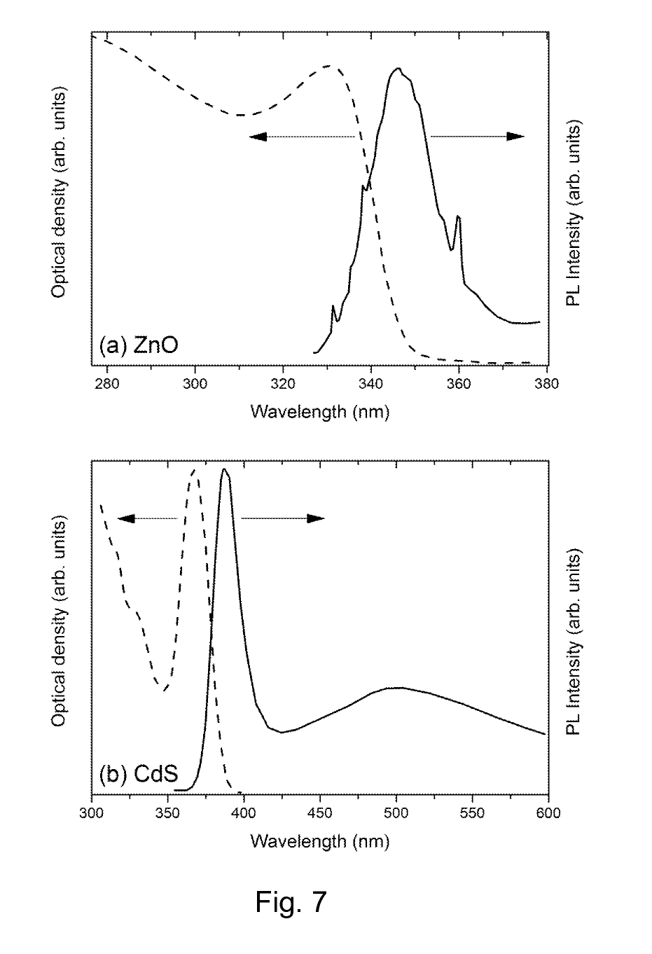

FIG. 7 shows a fluorescence spectral graph of (a) ZnO (from Decay Dynamics of ultraviolet photoluminescence in ZnO nanocryctals, S. Yamamoto et al., Journal of Luminescence 126 (2007) 257-262) and (b) CdS (from Lumidot™ CdS 400, core-type quantum dots, 5 mg/mL in toluene,

<http ://www.sigmaaldrich.com/catalog/product/aldrich/662410?lang=en&region=US>, last accessed Feb. 2, 2013). The dotted line graph is the absorption spectra, named “Optical density” and the solid line graph is the emission spectra named “PL (Photo-Luminescence) intensity. As shown in the graphs, both materials absorb short UV wavelengths and fluoresce at a longer wavelength range.

According to one aspect of the present invention, the embodiments described in FIGS. 1-6 above are configured to change the transparency faster than conventional photochromic devices. In other words, the devices according to the present invention are configured to become less transparent and to return to their original transparency values faster than conventional devices. According to one aspect of the present invention, the embodiments described in FIGS. 1-6 above are configured return to one-half of the initial tint value in between about a few seconds to about 25 seconds, depending on the type of material, at room temperature.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. An optical power-limiting composition for limiting optical power transmission for an entire solar UV spectrum, comprising:
photochromic dye molecules and UV fluorescent nanoparticles in a matrix material, the composition being configured to absorb wavelengths in the entire solar UV spectrum, including wavelengths of 300-340 nm, thereby enhancing photochromic responsiveness of the composition to solar light, wherein the composition includes a first side that receives impinging light and a second side opposed to the first side.

2. The composition of claim 1, further comprising environmental stabilizers in the matrix.

3. The composition of claim 1, wherein the photochromic dye molecules and the UV fluorescent nanoparticles are embedded in alternating layers of matrix material, including at least one layer of photochromic dye molecules in matrix and one layer of fluorescent nanoparticles in matrix, wherein the alternating layers optionally include environmental stabilizers.

4. The composition of claim 2, wherein the environmental stabilizers include hindered amine stabilizer (HALS), UV absorbers, thermal stabilizers, singlet oxygen quenchers, various antioxidants, and any combination thereof.

5. The composition of claim 1, further comprising a reflective layer for reflection of short UV wavelengths, the reflective layer being coupled to the second side.

6. The composition of claim 3, further comprising a reflective layer for reflection of short UV wavelengths, the reflective layer being coupled to the second side.

7. The composition of claim 1, wherein the photochromic dye molecules include organics, including pyrans, oxazines, fulgides, fulgimides, diarylethenes and any combination thereof, in monomeric or polymeric ungelled solution, or chemically bonded inorganic photochromics including crystallites of silver halides, cadmium halide, copper halide, and any combination thereof.

8. The composition of claim 1, wherein the UV fluorescent nanoparticles include nano-crystals or quantum dots of ZnO, ZnS, ZnSe, CdS, CdSe, gallium oxide, indium oxide, tin oxide or their alloys, mixtures and mixed composition particles, and any combination thereof.

9. The composition of claim 1, wherein the matrix materials include organic-based materials including polymer film, polymerizable compositions, transparent adhesives, and any combination thereof; or inorganic-based materials including mineral glass, sol-gel, other suitable window based materials, and any combination thereof; inorganic-organic composites, and any combination of such organic or inorganic-based materials.

10. The composition of claim 1, wherein the photochromic dye molecules and the UV fluorescent nanoparticles in the matrix material are shaped into nano-sphere capsules of a spherical shape of diameter of about 50-200 nm, the nano-sphere capsules being embedded in a transparent bulk.

11. The composition of claim 10, further comprising stabilizers embedded into the nano-sphere capsules.

12. The composition of claim 1, wherein the photochromic dye molecules are coated or encapsulated with a coating, the coating being configured to protect the composition from oxidation or degradation, to block out harmful radiation, to alter chemical nature of the photochromic dye molecules, to alter dispersability of the photochromic dye molecules, and any combination thereof.

13. The composition of claim 1, wherein a portion of the impinging light having wavelengths shorter than 340 nm is absorbed by the UV fluorescent nanoparticles, the UV fluorescent nanoparticles being configured to convert the light having wavelengths shorter than 340 nm to light having wavelengths between about 340 nm and 420 nm, the photochromic dye molecules being configured to absorb the light having wavelengths between about 340 nm and about 420 nm.

14. The composition of claim 1, further configured to absorb and convert to higher wavelength(s) a portion of the impinging light that is in the UV spectrum, wherein the light exiting the composition has wavelength(s) higher than the UV spectrum wavelength.

15. A composition for limiting optical power transmission for the entire solar UV spectrum, comprising: a transparent bulk material including nano-sphere capsules embedded therein, the nano-sphere capsules including photochromic dye molecules and UV fluorescent nanoparticles in a matrix, wherein the transparent bulk material includes a first side and a second side opposing the first side.

16. The composition of claim 15, wherein the nano-sphere capsules further include stabilizers.

17. The composition of claim 15, wherein the nano-spheres have a diameter of between about 50 and about 200 nm.

18. The composition of claim 15, wherein a portion of the impinging light having wavelengths shorter than 340 nm is absorbed by the UV fluorescent nanoparticles, the UV fluorescent nanoparticles being configured to convert the light having wavelengths shorter than 340 nm to light having wavelengths between about 340 nm and 420 nm, the photochromic dye molecules being configured to absorb the light having wavelengths between about 340 nm and about 420 nm.

19. The composition of claim 15, wherein the photochromic dye molecules include organics, including pyrans, oxazines, fulgides, fulgimides, diarylethenes and any combination thereof, in monomeric or polymeric ungelled solution, or chemically bonded inorganic photochromics including crystallites of silver halides, cadmium halide, copper halide, and any combination thereof.

20. The composition of claim 15, wherein the UV fluorescent nanoparticles include nano-crystals or quantum dots of ZnO, ZnS, ZnSe, CdS, CdSe, gallium oxide, indium oxide, tin oxide or their alloys, mixtures and mixed composition particles, and any combination thereof.
